(19) United States
(12) Patent Application Publication
(10) Pub. No.: US 2004/0172389 A1
(43) Pub. Date: Sep. 2, 2004

(54) System and method for automated tracking and analysis of document usage

(76) Inventors: Yaron Galai, Rishon Lezion (IL); Oded Itzhak, Modi'in (IL)

Correspondence Address: Anthony Castorina, G E Ehrlich, Suite 207, 2001 Jefferson Davis Highway, Arlington, VA, 22202, US

(21) Appl. No.: 10/483,997

(22) PCT Filed:
(86) PCT No.: PCT/IL02/00616

Related U.S. Application Data
(60) Provisional application No. 60/307,852, filed on Jul. 27, 2001.
(60) Provisional application No. 60/311,844, filed on Aug. 14, 2001.
(60) Provisional application No. 60/312,062, filed on Aug. 15, 2001.

(51) Int. Cl. G06F 7/00

(52) U.S. Cl. 707/3

(57) ABSTRACT

A system and a method for automatically submitting Web pages to a search engine, which is preferably used for sub-mitting dynamic Web pages, but may optionally be used for any type of Web page. According to the present invention, an embedded object is inserted into the Web page, which causes the URL of that Web page to be automatically sent to a Web server when that Web page is loaded by a Web browser. The Web server can then optionally automatically send the received URLs to the search engine, or alternatively, the autonomous software search program could retrieve the received URLs from the Web server. The embedded object itself is preferably inserted as code which is suitable for execution according to a Web-based protocol, such as by a Web browser and/or Web server, for example. There is also provided a system and a method for converting each URL or other Web page address into a normalized form.

### FIELD OF THE INVENTION

The present invention relates to a system and a method for submission of documents to a search engine, and in particular, for such a system and method in which the documents are constructed as mark-up language documents, such as Web pages written in HTML (HyperText Mark-up Language).

### BACKGROUND OF THE INVENTION

The World Wide Web is structured as a “two-party” system, in which a first party, the computer user, receives content from a second party, the Web server. The user typically requests the content in the form of mark-up language documents, such as Web pages written in HTML. In order to retrieve the desired Web page, the user submits a particular URL (uniform resource locator) to the Web server, which retrieves and transmits the desired Web page to the computer of the user. However, the user must know the correct URL, or else the Web page cannot be retrieved.

Since there are many Web pages available through the World Wide Web, search engines have evolved to assist the user in the search for a particular Web page. These search engines index Web pages according to one or more keywords, such that when the user submits the query for a particular Web page, those Web page(s) with the same or similar keywords as for the query are retrieved. Search engines may receive Web pages (or pointers to those Web pages, such as URLs for example) by submission from the author of the page(s), but the search engines also actively search for new Web pages. Typically, such active searches are performed automatically with autonomous software programs called “spiders” or “crawlers”. These autonomous software programs search through the World Wide Web by extracting links from known Web pages in order to locate new Web pages, to which the links point. As each new Web page is located, it is indexed and added to the database of the search engine and new links are extracted from that Web page. Search engines use the URL, as a unique identifier of the indexed page. Thus, the autonomous software programs depend upon two assumptions. First the Web pages existing as static entities, to which links remain stable. The second assumption is that web pages have incoming links pointing to them.

However, many Web pages today are provided as dynamic Web pages, which are created in real time or “on the fly” from a plurality of components stored in a database. Dynamic Web pages are created upon submission of a query by a user, which determines the identity of the components to be retrieved and assembled into the Web page. For example, a URL for a dynamic Web page, if it exists, may appear as follows: http://domain.com search.asp?pl.=ν/&p2=ν2. The term “search.asp” is a name of an application which should be invoked, followed by a “?” sign, and a list of parameters and their values. Many autonomous software search programs are designed to ignore such links, since automatically following this type of link may cause an infinite recursion which the autonomous software program cannot properly handle. Furthermore, such links may not exist at all, as the user may enter information through a scripting language form, such as JavaScript for example. which would then cause the dynamic Web page to be assembled according to the entered information. Thus, dynamic Web pages are often not indexed, or even “un-indexable”, by autonomous software search programs.

### SUMMARY OF THE INVENTION

The background art does not teach or suggest a solution to the problem of automatically indexing dynamic Web pages by an autonomous software search program. The background art also does not teach or suggest a solution to the inability of such programs to easily analyze, parse and index dynamic Web pages. Also, the background art does not teach or suggest a solution to such problems as repeated indexing of the same Web page and/or to the correct identification of URLs for dynamic Web pages. In addition, the background art also does not teach or suggest a solution to the problem of automatically specifically notifying a search engine about the existence of specific Web pages, without direct manual submission to the search engine. The background art also does not teach or suggest a mechanism for determining ranking information for a dynamic Web page or other type of dynamic document, with regard to the number of times that the Web page or other document is accessed. The background art also does not teach or suggest

The present invention overcomes these problems of the background art by providing a system and a method for automatically submitting Web pages to a search engine, which is preferably used for submitting dynamic Web pages, but may optionally be used for any type of Web page. The present invention is also useful for any document which can be identified and/or located according to a URI (Unified Resource Identifier), which acts as an address or pointer to that document. According to the present invention, particular code is inserted into the document, which causes the URI of that document to be automatically sent to another location, such as a server and/or search engine when that document is requested by a user. For example, for Web pages, the URL (URI of the Web page) could optionally be sent to the server and/or search engine when the Web page is loaded by a Web browser. If the URIs are not sent directly to the search engine, the server, such as a Web server for example, can then optionally automatically send the received URLs to the search engine, or alternatively, the search engine could retrieve the received URLs from the Web server.

Hereinafter, the term “search engine” includes but is not limited to, any type of autonomous software search program, such as a “spider” for searching for Web pages through the World Wide Web for example, as well as any type of repository and/or database, or other archiving or storage-based software.

Examples of documents for which the URI may optionally be submitted include, but are not limited to, Web pages, any document written in any type of mark-up language, e-mail messages, word processing documents such as those generated by Microsoft Word™ (Microsoft Corp, USA) for example, and documents written in the pdf format (Adobe Systems Inc., USA).

With regard to the non-limiting example of Web page documents, the code which is inserted into the Web page may optionally be written in a document mark-up language but may alternatively be written as an applet, a JavaScript or other type of code language which is suitable for Web pages.

According to another embodiment of the present invention, there is provided a system and a method for converting each URI into a normalized form. This system and method are optionally and preferably used for any type of URL or other Web page address. Hereinafter, the term “URL” is used to refer to any type of URI for a Web page, whether static or dynamic. Preferably, the present invention first automatically determines whether there are any redundant parameters in the URL, and more preferably removes them. This process is preferably invoked by an autonomous software search program and/or search engine in order to decide whether, and optionally when, this Web page was previously indexed. The process is also preferably used to help the autonomous software search program and/or search engine to decide whether the Web page should be retrieved, for example for indexing.

The present invention more preferably retrieves the Web page by using the complete URL to form an original Web page. Next, each of the parameters is preferably removed. The term “parameter” refers to any divisible subunit of the URL. The Web page is then retrieved again by using the reduced URL. This Web page is then compared with the original Web page. If the removed parameter(s) are not redundant, such that they are required for the correct retrieval of the original Web page and/or a sufficiently similar Web page, then the retrieved Web page would be completely different from the original Web page.

If the parameter is redundant, the Web pages may be expected to be similar, although perhaps not completely identical. Lack of identity may occur if the Web page includes one or more links with the complete URL, as for a session ID. Alternatively, the Web page could be custom tailored according to user identifying information, for personalization. Other types of dynamic Web pages may also occur, which may optionally produce a plurality of similar but not completely identical Web pages. For that reason, the comparison function of the present invention preferably checks for similarity in content and more preferably produces a similarity level, which is the likelihood of the two Web pages to have the same content. If this value exceeds a certain threshold then most preferably the removed parameter is considered to be redundant.

According to preferred embodiments of the present invention, the level of similarity is determined according to visual similarity. Visual similarity is preferably determined according to two different types of parameters. A first type of parameter is based upon content of the document, such as text and/or images for example. A second type of parameter is based upon visual layout characteristics of the document, such as the presence of one or more GUI (graphical user interface) gadgets or the location of text and/or images, for example. More preferably, the level of similarity is determined by comparing content-based parameters between documents, rather than by comparing visual layout characteristics. The use of content-based parameters is preferred because similarity is preferably determined according to the actual content or “meaning” of a document, with regard to being submitted to a search engine and/or otherwise stored.

The above process is preferably executed once per URL structure, and for each URL with the same structure. URLs which have the same structure preferably feature a fixed base template, optionally with one or more variable parameters. The redundant parameters are preferably removed automatically before the Web page is retrieved and indexed by the search engine.

The present invention is preferably used with regard to dynamic Web pages, but may optionally be used for any type of Web page. The present invention optionally and more preferably features a gateway server for modifying these Web pages for provision to the search engine, either directly or optionally through an autonomous software search program.

According to still another embodiment of the present invention, there is provided a method for ranking Web pages according to the dynamic popularity of the Web page. This dynamic popularity is determined according to the number of times that a Web page is viewed per time period. The time period may optionally be flexibly determined, but is preferably the same for all Web pages which are to be compared. More popular Web pages, or those which are viewed most frequently per time period, would receive higher rankings in any subsequent search results. This method has a number of advantages, including the ability to more accurately determine the current popularity of a Web page. For example, updated rankings could optionally be provided once a day or even more frequently if desired.

According to other preferred embodiments of the present invention, the popularity information could optionally and preferably be used for determining the amount to be charged for displaying a link to a Web page or other document to a user earlier in the display of search results. With regard to Web pages, the user typically receives search results in the form of a list of links to various Web pages. The order of links in the list may optionally be at least partially determined according to payment by the owners of the Web pages. The amount of this cost is preferably related to the popularity of the Web page. For example, the popularity information could optionally and preferably be used to determine the “cpc” (cost per click through), which is the amount charged to the owner of a Web page when the user clicks on or otherwise selects a particular link.

According to the present invention, there is provided a system for automatically submitting a Web page to a search engine, wherein the Web page features an embedded object, the system comprising: (a) a Web server for serving the Web page; (b) a Web browser for requesting the Web page from the Web server, and for receiving the Web page; and (c) a submission Web server for receiving at least a URL of the Web page through the embedded object, such that the search engine receives the URI from the submission Web server.

Preferably, the embedded object includes a URL for being in communication with the submission Web server, such that the Web browser sends a request to the submission Web server, the request including a URL of the Web page.

Also preferably, the embedded object actively communicates the URL of the Web page to the submission Web server.

Alternatively or additionally and preferably, a single server comprises the submission Web server and the Web server.

Optionally and preferably, the embedded object comprises HTML code.

Also preferably, the embedded object comprises an applet. More preferably the embedded object comprises a scripting code.

According to preferred embodiments of the present invention, there is additionally provided (e) an autonomous software search program for retrieving the URL from the submission Web server and for providing the URL to the search engine.

Preferably, the submission Web server retrieves additional information with the URL, the additional information being provided to the search engine with the URL.

Also preferably, the Web page is a dynamic Web page.

According to other preferred embodiments of the present invention, the submission Web server normalizes the URL for the Web page for the search engine. More preferably, the normalizing comprises removing at least one redundant parameter from the URL to form a normalized URL.

According to another embodiment of the present invention, there is provided a system for automatically submitting a Web page to a search engine, wherein the Web page features an embedded object, comprising: (a) a Web server for serving the Web page; (b) a Web browser for requesting the Web page from the Web server, such that when the Web page is received, the embedded object is activated; and (c) a submission Web server for receiving at least a URL of the Web page upon activation of the embedded object.

Preferably, the submission Web server and the Web server are the same server. More preferably, the embedded object comprises an applet. Optionally and more preferably, the embedded object comprises a scripting code.

Most preferably, the system further comprises (e) an autonomous software search program for retrieving the URL from the submission Web server and for providing the URL to the search engine.

Also most preferably, the submission Web server retrieves additional information with the URL, the additional information being provided to the search engine with the URL.

Alternatively or additionally, the Web page is preferably a dynamic Web page.

According to preferred embodiments of the present invention, at least one of the autonomous software search program, the search engine and the submission Web server normalizes the URL for the Web page. Preferably, the normalizing comprises removing at least one redundant parameter from the URL to form a normalized URL.

According to still other embodiments of the present invention, there is provided a method for automatically submitting a Web page to a search engine, the Web page featuring an embedded object, comprising: requesting the Web page by a Web browser, upon receipt of the Web page by the Web browser, automatically invoking a request for the embedded object; and receiving at least the URL of the Web page by the search engine through the request.

Preferably, the embedded object invokes the request directly.

Alternatively or additionally and preferably, the Web browser transmits the request for the embedded object, the automatically invoking further comprising: receiving the request by an object server, the request including the URL of the Web page; and transmitting at least the URL of the Web page by the object server.

More preferably, the receiving further comprises: normalizing the URL for the Web page for the search engine. Most preferably, the normalizing comprises removing at least one redundant parameter from the URL to form a normalized URL.

According to yet other embodiments of the present invention, there is provided a method for normalizing a URL for a Web page, comprising: removing at least one redundant parameter from the URL to form a normalized URL.

Preferably, all redundant parameters are removed. More preferably, each redundant parameter is removed by: removing a parameter from the URL to form a reduced URL; retrieving a new Web page according to the reduced URL; and comparing the new Web page and the Web page to determine similarity, such that similarity indicates that the parameter is redundant.

Most preferably, similarity is determined according to content of the new Web page and the Web page. Also most preferably, similarity is determined according to a quantitative comparison, such that if similarity is above a threshold, the parameter is redundant. Most preferably, the quantitative comparison is determined by comparing content of the new Web page and the Web page. Still more preferably, the quantitative comparison is performed by also comparing layout of the new Web page and the Web page.

Preferably, the quantitative comparison is determined by only comparing content of the new Web page and the Web page, and wherein content comprises at least one of text and image.

According to preferred embodiments of the present invention, the removal of parameters and the comparison of the content in order to determine redundancy of parameters are done either automatically or manually. Preferably, the URL is normalized before the Web page is provided to a search engine.

According to still another embodiment of the present invention, there is provided a method for ranking a Web page, comprising: defining a time period for dynamically ranking Web pages; detecting a request for the Web page from a Web browser; determining a frequency of requests per the defined time period; and ranking the Web page according to the frequency of requests per the defined time period to determine the popularity of the Web page.

Preferably, the Web page contains an embedded object for reporting a request to download the Web page by a Web browser. More preferably, the embedded object causes the Web browser to invoke a request according to the HTTP protocol, the request being detected to report the request to download the Web page.

Also more preferably, the frequency of requests per time period is used to determine a weight for ranking the Web page. Most preferably, the method further comprises searching a plurality of Web pages to provide search results; and ranking the plurality of Web pages in the search results according to the weight. Also most preferably, the plurality of Web pages is ranked according to the weight as a primary ranking parameter.

Alternatively, the plurality of Web pages is ranked according to the weight as a secondary ranking parameter.

Preferably, the weight is adjusted according to a popularity of at least one other Web page in a Web site containing the Web page. More preferably, the weight is adjusted according to at least one of a number of times the Web page is viewed by unique users and unique IP addresses.

According to preferred embodiments of the present invention, there is further provided determining a billing rate for an advertisement with the Web page according to the ranking. Preferably, the advertisement is for displaying at least one of a link to the Web page and the Web page in a list, wherein the list is generated by a search engine performing a search for Web pages. More preferably, the billing rate is for click through on the advertisement.

According to yet another embodiment of the present invention, there is provided a method for automatically submitting an URI of a document to a repository, the document featuring an embedded object, the method comprising: requesting the document by a user application capable of displaying the document; receiving the document by the user application; automatically invoking a request for the embedded object when displaying the document by the user application; and receiving at least the address of the document by the repository through the request.

Preferably, the embedded object invokes the request directly. More preferably, the embedded object communicates the address to the repository directly. Also more preferably, the user application transmits the request for the embedded object, and wherein the automatically invoking further comprises: receiving the request by an object server, the request including the address of the document; and transmitting at least the address of the document by the object server to the repository.

Most preferably, the document comprises an e-mail message, and wherein automatically invoking the request includes information about a time that the e-mail message has been opened by user application.

Hereinafter, the term “computational device” refers to any type of computer hardware system and/or to any type of software operating system, or cellular telephones, as well as to any type of device having a data processor and/or any type of microprocessor, or any type of device which is capable of performing any function of a computer. For the present invention, a software application or program could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

Hereinafter, the term “Web browser” refers to any software program which can display text, graphics, or both, from Web pages on World Wide Web sites. Hereinafter, the term “Web page” refers to any document written in a mark-up language including, but not limited to, HTML (hypertext mark-up language) or VRML (virtual reality modeling language), dynamic HTML. XML (extended mark-up language) or related computer languages thereof, as well as to any collection of such documents reachable through one specific Internet address or at one specific World Wide Web site, or any document obtainable through a particular URL (Uniform Resource Locator). Hereinafter, the term “Web site” refers to at least one Web page, and preferably a plurality of Web pages, virtually connected to form a coherent group. Hereinafter, the term “Web server” refers to a computer or other electronic device which is capable of serving at least one Web page (or other web elements such as a graphic file) to a Web browser.

Hereinafter, the term “applet” refers to a self-contained software module written in an applet language such as Java or constructed as an ActiveX™ control. Hereinafter, the term “client” refers to any type of software program and/or code and/or other instructions which are operated and/or preformed by the computational device of the user.

Hereinafter, the term “network” refers to a connection between any two or more computers which permits the transmission of data.

Hereinafter, the phrase “display a Web page” includes all actions necessary to render at least a portion of the information on the Web page available to the computer user. As such, the phrase includes, but is not limited to, the static visual display of static graphical information the audible production of audio information, the animated visual display of animation and the visual display of video stream data

Hereinafter, the term “embedded object” refers to any part of a document such as a Web page for example, but not limited to Web pages and/or to documents written in a mark-up language, which is present at least for the purpose of operating the present invention.

### BRIEF DESCRIPTION OF THE DRAWINGS

The invention is herein described, by way of example only, with reference to the accompanying drawings, wherein:

FIG. 1 is a schematic block diagram of an exemplary system according to the present invention for submitting documents to search engines;

FIG. 2 is a flowchart of an exemplary method according to the present invention for submitting such documents;

FIG. 3 shows a flowchart of an exemplary method according to the present invention for normalizing address information for the documents to be submitted;

FIG. 4 is a schematic block diagram of an exemplary system according to the present invention for determining the popularity or “rank” of submitted documents; and

FIG. 5 is a flowchart of an exemplary method according to the present invention for performing such a determination of popularity.

### DESCRIPTION OF THE PREFERRED EMBODIMENTS

The present invention is of a system and a method for automatically submitting Web pages to a search engine, which is preferably used for submitting dynamic Web pages but may optionally be used for any type of Web page. According to the present invention, an embedded object is inserted into the Web page, which causes the URL of that Web page to be automatically sent to a Web server when that Web page is loaded by a Web browser. It should be noted that although reference is made to “Web pages” and “Web servers”, this is for the purpose of illustration only and is without any intention of being limiting, as in fact the present invention is operative with any type of document and/or any type of server for providing a document.

The present invention is also useful for any document which can be identified and/or located according to a URI (Unified Resource Identifier), which acts as an address or pointer to that document. According to the present invention, particular code is inserted into the document, which causes the URI of that document to be automatically sent to another location, such as a server and/or search engine when that document is requested by a user. For example, for Web pages, the URL (URI of the Web page) could optionally be sent to the server and/or search engine when the Web page is loaded by a Web browser. If the URIs are not sent directly to the search engine, the server, such as a Web server for example, can then optionally automatically send the received URLs to the search engine, or alternatively, the search engine could retrieve the received URLs from the Web server.

Optionally and more preferably, as described in greater detail below, the URI is parsed, by the autonomous software search program and/or the receiving Web server, in order to remove redundant information, such as redundant parameters for example.

Hereinafter, the term “search engine” includes but is not limited to, any type of autonomous software search program, such as a “spider” for searching for Web pages through the World Wide Web for example, as well as any type of repository and/or database, or other archiving or storage-based software.

Examples of documents for which the URI may optionally be submitted include, but are not limited to, Web pages, any document written in any type of mark-up language, e-mail messages, word processing documents such as those generated by Microsoft Word™ (Microsoft Corp, USA) for example, and documents written in the PDF format (Adobe Systems Inc., USA).

With regard to a non-limiting example of an e-mail message as the document, the user application preferably automatically invokes a request for an embedded object upon opening this message by the user application. More preferably, such a request includes information about a time that the e-mail message has been opened by user application. The method of the present invention is useful for any type of e-mail message, including those messages which are typically displayed through Web pages. The method of the present invention is operative with any type of e-mail applications which can transmit, receive and/or display e-mail messages, preferably those messages that are written in a mark-up language. In any case, the messages may optionally include embedded objects such as images.

With regard to the non-limiting example of Web page documents, the embedded object itself is preferably inserted as code which is suitable for execution according to a Web-based protocol, such as by a Web browser and/or Web server, for example.

Optionally and preferably the inserted code is part of a template Web page; according to which the dynamic Web page is assembled. Therefore, all dynamic Web pages which are constructed from the template Web page as a base would be exposed to the search engine by the inserted code.

The code which is inserted into the Web page may optionally be written in a document mark-up language, but may alternatively be written as an applet, a JavaScript or other type of code language which is suitable for Web pages. As an example only, without any intention of being limiting, the code may optionally and preferably be written as HTML code. For example the code is optionally as follows: <img src=http://domain-name width=“1” height=“1”>. This code causes the Web browser loading this code to automatically send a request to the Web server specified by “domain-name”, in order to retrieve the “image” (this code is an example of an “image tag”). The Web server extracts the referrer field from the HTTP header, which is the URL of the Web page containing the above code, which invoked the request. This URL is then stored by the Web server, and passed to and/or retrieved by a search engine for indexing.

Another non-limiting example of a code which could be used is a reference to an invisible image: <IMG SRC=“http://www.SubmissionWeb Server.com/submit?URLpartI/partII/partIII” WIDTH=“0” HEIGHT=“0” BORDER=“0”>. This image would be requested by the Web browser from the above-referenced URL or address (the portion in quotes between “http” and “submit”) when the Web browser requested the Web page. The portion of the URL after “submit?” is an example of a mechanism for providing the entire URL to the submission Web server through the actual request, without requiring a reference to the HTTP header, according to the present invention. The information provided after “submit?” includes the URL of the originating Web page.

Whenever a page is loaded by any browser, the browser makes an HTTP request to the Web server asking for the gif. The submission Web server extracts the “submit” field from the HTTP header, which is the fill URL of the requested page. This field is optionally and preferably normalized, as described in greater detail below.

If JavaScript code is to be used, as another illustrative, non-limiting example, then the URL of the Web page is extracted by using the document.location command. The extracted Web page is then sent to the Web server by using a reference to an image (or any other reference which makes the Web browser automatically invoke an HTTP request to the particular Web server).

According to another embodiment of the present invention, there is provided a system and a method for converting each URL or other Web page address into a normalized form. Hereinafter, the term “URL” is used to refer to any type of Internet or network address for pointing to a document such as a Web page, whether static or dynamic. Preferably, the present invention first automatically determines whether there are any redundant parameters in the URL, and more preferably removes them. This process is preferably invoked by an autonomous software search program and/or search engine in order to decide whether, and optionally when, this Web page was previously indexed. The process is also preferably used to help the autonomous software search program and/or search engine to decide whether the Web page should be retrieved, for example for indexing.

The present invention more preferably retrieves the Web page by using the complete URL to form an original Web page. Next, each of the parameters is preferably removed. The term “parameter” refers to any divisible subunit of the URL. The Web page is then retrieved again by using the reduced URL. This Web page is then compared with the original Web page. If the removed parameter(s) are not redundant, such that they are required for the correct retrieval of the original Web page, then the retrieved Web page would be completely different from the original Web page.

If the parameter is redundant, the Web pages may be expected to be similar, although perhaps not completely identical. Lack of identity may occur if the Web page includes one or more links with the complete URL, as for a session ID. Alternatively, the Web page could be custom tailored according to user identifying information, for personalization. Other types of dynamic Web pages may also occur, which may optionally produce a plurality of similar but not completely identical Web pages. For that reason, the comparison function of the present invention preferably checks for similarity in content and more preferably produces a similarity level, which is the likelihood of the two Web pages to have the same content. If this value exceeds a certain threshold, then most preferably the removed parameter is considered to be redundant.

According to preferred embodiments of the present invention, the level of similarity is determined according to visual similarity. Visual similarity is preferably determined according to two different types of parameters. A first type of parameter is based upon content of the document, such as text and/or images for example. A second type of parameter is based upon visual layout characteristics of the document, such as the presence of one or more GUI (graphical user interface) gadgets or the location of text and/or images, for example. More preferably the level of similarity is determined by comparing content-based parameters between documents, rather than by comparing visual layout characteristics. The use of content-based parameters is preferred because similarity is preferably determined according to the actual content or “meaning” of a document, with regard to being submitted to a search engine and/or otherwise stored.

The above process is preferably executed once per URL structure, more preferably in a preprocessing stage. The process is then preferably repeated for each URL with the same structure, more preferably in “real time”, for example upon request by the search engine or autonomous search software program. The term “URL structure” may include a group of the same parameters within a URL. However, preferably URLs which have the same structure are defined as having a fixed base template, optionally with one or more variable parameters. The redundant parameters are preferably removed automatically before the Web page is retrieved and indexed by the search engine.

The present invention is preferably used for normalizing URLs of dynamic Web pages, but may optionally be used for any type of Web page. The present invention optionally and more preferably features a gateway server for modifying these Web pages for provision to the search engine, either directly or optionally through an autonomous software search program.

According to still another embodiment of the present invention, there is provided a method for ranking Web pages according to the dynamic popularity of the Web page. This dynamic popularity is determined according to the number of times that a Web page is viewed per time period. The time period may optionally be flexibly determined, but is preferably the same for all Web pages which are to be compared. The viewing frequency of the page is used to assign a weight to the page, which can optionally be used when ranking the search results as a primary sorting parameter or as a secondary sorting parameter.

According to an optional but preferred embodiment of the present invention, the viewing frequency of Web pages is determined by inserting an embedded object into tile Web page, which causes the URL of that Web page to be automatically sent to a Web server when that Web page is loaded by a Web browser. The Web server can then optionally automatically send the received URLs to the search engine, or alternatively, the autonomous software search program could retrieve the received URLs from the Web server. The embedded object itself is preferably inserted as code which is suitable for execution by any application supporting Web-based protocol, such as by a Web browser and/or Web server, for example.

The code which is inserted into the Web page may optionally be written in a document mark-up language, but may alternatively be written as an applet, a JavaScript or other type of code language which is suitable for Web pages. As an example only, without any intention of being limiting, the code may optionally and preferably be written as HTML code. For example, the code is optionally as follows: <img src=“http://domain-name/image gif”width=“1” height=“1”>. This code causes the Web browser loading this code to automatically send a request to the Web server specified by “domain-name”, in order to retrieve the “image” (this code is an example of an “image tag”). The Web server extracts the referrer field from the HTTP header, which is the URL of the Web page containing the above code, which invoked the request. This URL is then stored by the Web server, and passed to and/or retrieved by a search engine for indexing.

If JavaScript code is to be used, as another illustrative, non-limiting example, then the URL of the Web page is extracted by using the document.location command. The extracted Web page is then sent to the Web server by using a reference to an image (or any other reference which makes the Web browser automatically invoke an HTTP request to the particular Web server).

According to a preferred embodiment of the present invention, each Web page is given a weight, which is a function of the viewing frequency of the Web page, or the number of times that the Web page has been viewed per time period. More preferably, this weight is adjusted according to the popularity of the Web site which contains the Web page, in order to normalize comparisons of individual Web page from different Web sites.

Most preferably, the viewing frequency is adjusted and/or augmented according to the number of times that a Web page is viewed by unique users and/or according to unique IP addresses of the computational devices which request the Web page. The number of times that the Web page is viewed by unique users is optionally and more preferably determined from the URL of the Web page. The submission Web server that receives the request stores the URLs on a database. For each URL, the submission Web server stores its viewing frequency and optionally a list of unique IP addresses which downloaded the page. The submission Web server can optionally store additional information such as history of viewing frequencies, total number of page impressions etc. These additional statistics may optionally be combined with the viewing frequency to form a single weight, for example by normalizing viewing frequency according to one or both of these different measurements.

These rankings are suitable for searches over a few Web sites, as well as searches which are not restricted to a portion of the Web and/or to one or more preselected Web sites. Optionally, the weight is used as the primary sorting parameter. Alternatively, the weight is used as a secondary (or lower) sorting parameter.

The method of the present invention for ranking has a number of advantages, including the ability to more accurately determine the current popularity of a Web page. For example, updated rankings could optionally be provided once a day or even more frequently if desired.

According to other preferred embodiments of the present invention, the popularity information could optionally and preferably be used for determining the amount to be charged for displaying a link to a Web page or other document to a user earlier in the display of search results. With regard to Web pages, the user typically receives search results in the form of a list of links to various Web pages. The order of links in the list may optionally be at least partially determined according to payment by the owners of the Web pages. The amount of this cost is preferably related to the popularity of the Web page. For example, the popularity information could optionally and preferably be used to determine the “cpc” (cost per click through), which is the amount charged to the owner of a Web page when the user clicks on or otherwise selects a particular link. The principles and operation of the system and method according to the present invention may be better understood with reference to the drawings and the accompanying description. It should be noted that the present invention is operable with any type of computational device network environment, in which information is to be collected about documents, and/or in which the documents themselves are to be collected. The present invention is preferably operated with regard to an IP network environment, although optionally any type of networked, distributed client-server environment could be used for the present invention.

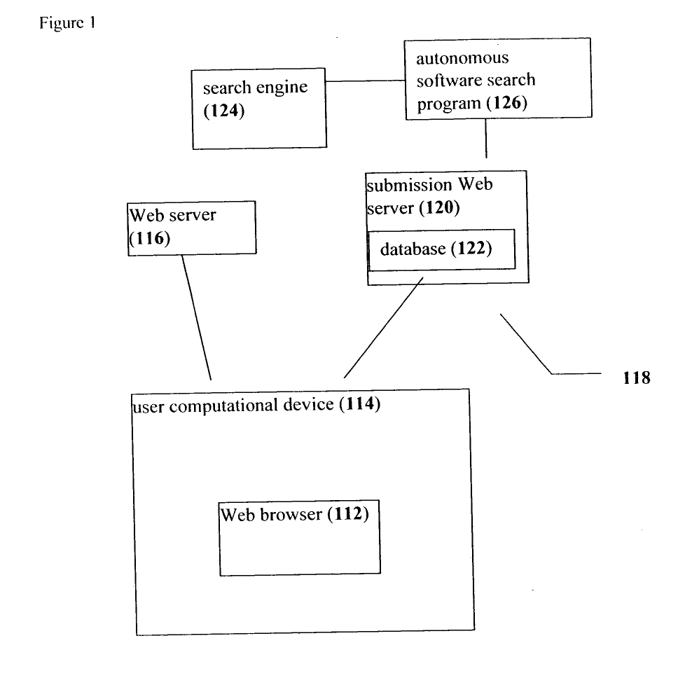

Referring now to the drawings, FIG. 1 shows an illustrative system 10, in which a user interacts with a Web browser 112 being operated by a user computational device 114. Web browser 112 receives content from, and sends commands to, a Web server 116, according to the HTTP (HyperText Transfer Protocol) protocol. Web server 116 is connected to user computational device 114, and hence is able to communicate with Web browser 112, through a network 118. Network 118 may be the Internet, for example.

User computational device 114 is also preferably in communication with a submission Web server 120 through network 118. When Web browser 112 requests a particular Web page through user computational device 114, the Web page contains an embedded object, which causes Web browser 112 to communicate with submission Web server 120. Preferably, the communication is in the form of an automatically generated request by Web browser 112, for example a request that is generally submitted to retrieve a particular Web page component, such as an image for example. The request is directed to the submission Web server 120, and includes the URL of the originating Web page, such that submission Web server 120 is preferably able to parse the request in order to retrieve the URL.

Once submission Web server 120 has parsed the request, and retrieved the URL, submission Web server 120 preferably stores the URL in a database 122. Database 122 may optionally also contain other information retrieved with the request by submission Web server 120, such as the date and time, approximate geographic location of user computational device 114. A search engine 124 may then optionally retrieve the URL from database 122, and/or submission Web server 120 may optionally and more preferably serve the URL to search engine 124, most preferably with any related information about the associated Web page, if available.

According to preferred embodiments of the present invention, the URL, optionally with related information, is provided to search engine 124 indirectly. An autonomous software search program 126 preferably interacts with submission Web server 120 in order to retrieve the URL, with optional related information. Autonomous software search program 126 then preferably provides the URL, with optional related information, to search engine 124. Thus, search engine 124 is able to retrieve URLs for any type of Web pages, even if those Web pages do not have a static form and/or content, such as for dynamic Web pages for example.

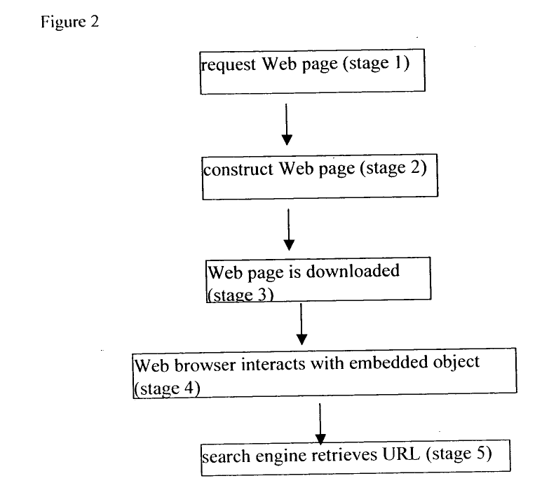

FIG. 2 is a flowchart of an exemplary method for automatically submitting Web pages to a search engine. As shown, in stage 1, the user requests a Web page through a Web browser. The Web page is optionally requested through a link, but preferably is requested after certain information is provided by the user, for example by entering data into a form and/or by selecting one or more choices from a menu. In stage 2, the Web page is optionally and preferably constructed “on the fly”, in real time, according to the request of the user. The constructed Web page preferably includes an embedded object according to the present invention. In stage 3, the Web page is downloaded to the computational device of the user and is displayed by the Web browser.

In stage 4, the Web browser preferably interacts with the embedded object thereby causing certain information to be returned to a submission Web server. It should be noted that although submission Web server is optionally the same Web server which provided the Web pagc. preferably two separate such servers are provided. The information which is returned to the submission Web server includes the URL of the Web page, and optionally includes other information as well.

In stage 5, a search engine retrieves the information about the Web page, including at the least the URL, from the submission Web server. Optionally, such retrieval is performed directly, but preferably an autonomous software search program is used to retrieve the URL, from the submission Web server. The autonomous software search program then preferably provides the URL with the optional related information to the search engine.

According to preferred embodiments of the present invention, the URL or other address which is sent to the search engine is normalized or otherwise adjusted according to the requirements of the search engine. For example, search engines which receive Web pages optionally and preferably receive the URL without redundant parameters.

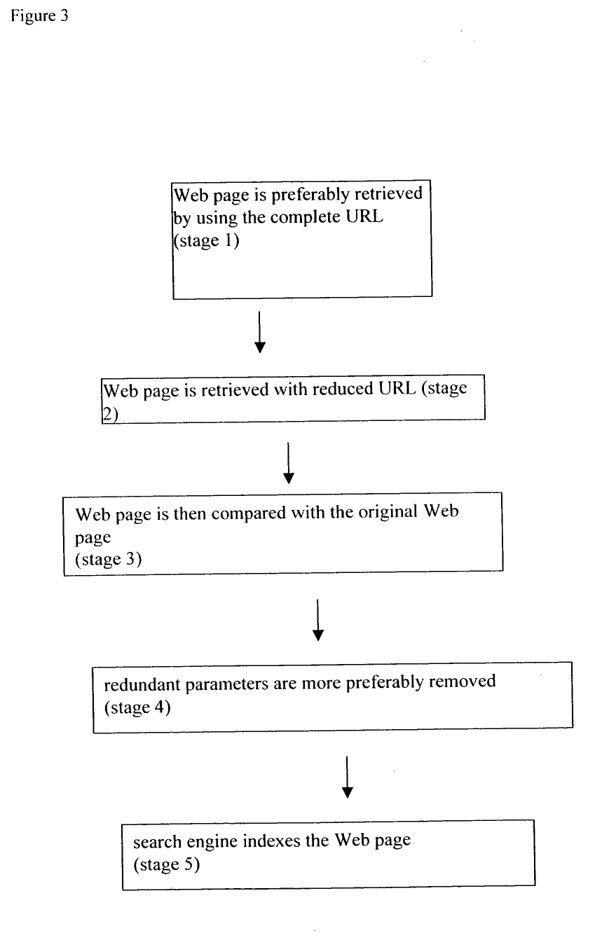

FIG. 3 shows a flowchart of an exemplary method for normalizing a URI, such as the URL of a Web page for example. Such normalization is optionally and preferably performed before the Web page or other document is submitted to the search engine and/or autonomous search software program for indexing as previously described. This process is optionally and preferably invoked by the autonomous software search program and/or search engine in order to decide whether, and optionally when, this Web page was previously indexed. The process is also preferably used to help the autonomous software search program and/or search engine to decide whether the Web page should be retrieved, for example for indexing.

As shown, in stage 1, the Web page is preferably retrieved by using the complete URL to form an original Web page. In stage 2, each of the parameters is preferably removed and the Web page is retrieved again by using the reduced URL. The term “parameter” refers to any divisible subunit of the URL. In stage 3, this Web page is then compared with the original Web page. If the removed parameter(s) are not redundant, such that they are required for the correct retrieval of the original Web page, then the retrieved Web page would be completely different from the original Web page.

If the parameter is redundant, the Web pages may be expected to be similar, although perhaps not completely identical. Lack of identity may occur if the Web page includes one or more links with the complete URL, as for a session ID. Alternatively, the Web page could be custom tailored according to user identifying information, for personalization. For that reason the comparison function of the present invention preferably checks for similarity in content and more preferably produces a similarity level, which is the likelihood of the two Web pages to have the same content. If this value exceeds a certain threshold, then most preferably the removed parameter is considered to be redundant.

According to preferred embodiments of the present invention, the level of similarity is determined according to visual similarity. Visual similarity is preferably determined according to two different types of parameters. A first type of parameter is based upon content of the document, such as text and/or images for example. A second type of parameter is based upon visual layout characteristics of the document, such as the presence of one or more GUI (graphical user interface) gadgets or the location of text and/or images, for example. More preferably, the level of similarity is determined by comparing content-based parameters between documents, rather than by comparing visual layout characteristics. The use of content-based parameters is preferred because similarity is preferably determined according to the actual content or “meaning” of a document, with regard to being submitted to a search engine and/or otherwise stored. The above process is preferably executed once per URL structure, and for each URL with the same structure. Therefore, stages 1-3 are optionally and preferably repeated for each URL structure. Once a parameter and/or a URL structure has been identified as occurring repeatedly. optionally and preferably, stages 1-3 are not performed again for such repeated parameters and/or URL structures.

In stage 4, these redundant parameters are more preferably removed. The redundant parameters are preferably removed automatically before the Web page is retrieved and indexed by the search engine in stage 5.

According to other preferred embodiments of the present invention, the present invention includes a system and method for determining the popularity or ranking of Web pages and/or other documents, for example according to the relative frequency at which the Web page or other document is requested.

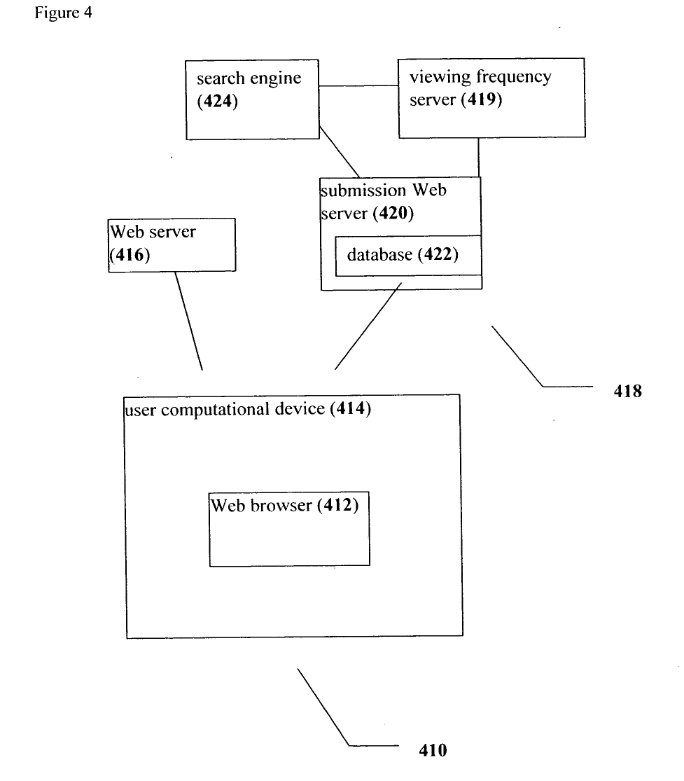

FIG. 4 shows an illustrative system 410 for determining the popularity of Web pages according to the viewing frequency per time period. Any type of time period may optionally be used, such as a day or an hour for example, although such a time period is preferably predetermined. The use of viewing frequency per time period is important, since otherwise the true popularity of a particular document cannot be accurately assessed.

A user interacts with a Web browser 412 being operated by a user computational device 414. Web browser 412 receives content from, and sends commands to, a Web server 416. according to the HTTP (HyperText Transfer Protocol) protocol. Web server 416 is connected to user computational device 414, and hence is able to communicate with Web browser 412, through a network 418. Network 418 may be the Internet, for example. The frequency with which different users request the Web page through their respective Web browsers 412 and user computational devices 414 determines the viewing frequency.

The viewing frequency is optionally measured by a viewing frequency server 419, which may optionally provide this information to a search engine 424. Search engine 424 then preferably uses the viewing frequency as at least part of a ranking mechanism for determining the rank of Web pages in search results, for example as a primary or secondary sorting parameter for determining the order of Web pages in the search results. More preferably, this weight is adjusted by submission web server 420 and/or search engine 424 and/or by viewing frequency server 419 according to the popularity of the Web site that contains the Web page, in order to normalize comparisons of individual Web pages from different Web sites.

Most preferably, the viewing frequency is adjusted and/or augmented according to the number of times that a Web page is viewed by unique users and/or according to unique IP addresses of computational devices 414, and/or is downloaded to a proxy server (not shown) connected to computational device 414 through network 418, which request the Web page. The number of times that the Web page is viewed by unique users can be extracted from database 422. These additional statistics may optionally be combined with the viewing frequency to form a single weight, for example by normalizing viewing frequency according to one or both of these different measurements.

According to a preferred embodiment of the present invention, the viewing frequency is determined by including an embedded object in the Web page. Optionally and more preferably, this embedded object is the same embedded object which is used for submission to search engine, for example, as previously described. For this embodiment, user computational device 414 is also preferably in communication with a submission Web server 420 through network 418. When Web browser 412 requests a particular Web page through user computational device 414, the embedded object causes Web browser 412 to communicate with submission Web server 420. Preferably, the communication is in the form of an automatically generated request by Web browser 412, for example a request which is generally submitted to retrieve a particular Web page component, such as an image for example. The request is directed to the submission Web server 420, and includes the URL of the originating Web page, such that submission Web server 420 is preferably able to parse the request in order to retrieve the URL.

Once submission Web server 420 has parsed the request, and retrieved the URL, submission Web server 420 preferably stores the URL and/or the frequency with which the URL is requested in a database 422. Database 422 may optionally also contain other information retrieved with the request by submission Web server 420, such as the date and time, approximate geographic location of user computational device 414. This information is then preferably provided to search engine 424 and/or viewing frequency server 419 for determining the ranking of Web pages.

According to other optional but preferred embodiments of the present invention; viewing frequency server 419 may preferably perform a statistical analysis on the frequency of viewing (displaying) of Web pages and/or other documents. Such statistical analysis may optionally be used to determine which users request the Web page and/or other document (for example, according to Web browser 412). Such information may be particularly useful in the corporate environment, in order to assess the efficacy of providing documents to employees “on-line”, through a corporate network for example.

Alternatively or additionally, viewing frequency server 419 may optionally and preferably determine prices of “clicking through” or otherwise selecting links to various Web pages, for example for advertisements, according to the information about popularity.

Also alternatively or additionally, viewing frequency server 419 may optionally index or otherwise gather Web pages and/or other documents for submission to submission Web server 420 and/or search engine 424 according to popularity or other statistical analysis of viewing frequency.

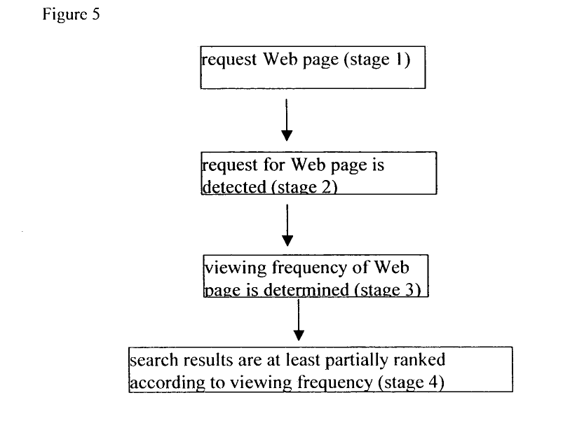

FIG. 5 is a flowchart of an exemplary method for ranking Web pages. As shown, in stage 1, the user requests a Web page through a Web browser. In stage 2, the request for the Web page is detected for determining the viewing frequency. Preferably, such detection occurs through the provision of an embedded object, which reports the request to another entity, such as a search engine or a different (ranking) server for example. The Web browser preferably interacts with the embedded object, thereby causing certain information to be returned to a submission Web server. It should be noted that although submission Web server is optionally the same Web server which provided the Web page, preferably two separate such servers are provided. The information which is returned to the submission Web server includes the URL of the Web page or at least an indication that this URL was requested for viewing, and optionally includes other information as well.

In stage 3, the viewing frequency of the Web page is determined in order to provide a weight which indicates the dynamic popularity of the Web page. More preferably, this weight is adjusted according to the popularity of the Web site which contains the Web page in order to normalize comparisons of individual Web page from different Web sites. Most preferably, the viewing frequency is adjusted and/or augmented according to the number of times that a Web page is viewed by unique users and/or according to unique IP addresses of the computational devices which request the Web page.

In stage 4, a search engine receives a request for a search from a user. The results of this search are ranked at least partially according to the weight accorded to the different Web pages. This weight is optionally used as the primary or secondary sorting parameter.

There are a number of potential different uses for the popularity parameter. For example, the popularity parameter can optionally be used in the relevancy ranking algorithm of the search engines, since more popular pages may optionally have a higher rank. This parameter can optionally be used as a primary sorting parameter or as secondary sorting parameter for determining the order in which the results of the search are presented.

The popularity parameter can optionally be used to exclude less popular pages from the search index. Alternatively or additionally, it can be used by Web sites that advertise Web pages on a pay-per-click basis, for example for displaying the Web page first or at least earlier in the search results presented by the search engine. The cost-per-click of a Web page could then optionally and preferably be a function of the popularity of the Web page.

The present invention provides a number of advantages over currently available solutions. For example, most autonomous software search programs simply ignore dynamic Web pages, as being too difficult to detect and/or analyze, once detected. Those programs which do attempt to handle such dynamic Web pages may encounter such problems as infinite recursion within the available links, as links to dynamic Web pages do not point to any particular static or fixed Web page, but instead to a potential collection of items an-arranged as a Web page. Thus, the present invention overcomes a number of problems with the background art solutions Other advantages of the present invention include, but are not limited to, providing access to potentially all Web pages and/or other documents, even if they were generated by form submission and did not have incoming links; optionally provision of control to the Web site owner as to which pages are submitted, through the use of the submission code; optionally and preferably, being able to determine the popularity or “ranking” of Web pages and/or other documents; immediate provision of information about a new Web page and/or other document immediately after it was first requested; and optional extraction of additional data from the HTTP header such as IP address which can be used to get demographic data. This optionally extracted additional information can optionally and preferably be used to create demographic-based indexes (for example, to create a search engine for users who are located in a particular country).

While the invention has been described with respect to a limited number of embodiments, it will be appreciated that many variations, modifications and other applications of the invention may be made.

What is claimed is:

1. A system for automatically submitting a Web page to a search engine, wherein the Web page features an embedded object, comprising:
(a) a Web server for serving the Web page;
(b) a Web browser for requesting the Web page from said Web server, and for receiving the Web page; and
(c) a submission Web server for receiving at least a URL of the Web page through the embedded object, such that the search engine receives the URI from said submission Web server.

2. The system of claim 1, wherein the embedded object includes a URL for being in communication with said submission Web server, such that said Web browser sends a request to said submission Web server, said request including a URL of the Web page.

3. The system of claim 1, wherein the embedded object actively communicates said URL of the Web page to said submission Web server.

4. The system of claim 1, wherein a single server comprises said submission Web server and said Web server.

5. The system of claim 1, wherein the embedded object comprises HTML code.

6. The system of claim 1, wherein the embedded object comprises an applet.

7. The system of claim 6, wherein the embedded object comprises a scripting code.

8. The system of claim 1, further comprising:
(e) an autonomous software search program for retrieving said URL from said submission Web server and for providing said URL to the search engine.

9. The system of claim 1, wherein said submission Web server retrieves additional information with said URL, said additional information being provided to the search engine with said URL.

10. The system of claim 1, wherein the Web page is a dynamic Web page.

11. The system of any of claims 1-10, wherein said submission Web server normalizes the URL for the Web page for the search engine.

12. The system of claim 11, wherein said normalizing comprises removing at least one redundant parameter from the URL to form a normalized URL.

13. A system for automatically submitting a Web page to a search engine, wherein the Web page features an embedded object, comprising:
(a) a Web server for serving the Web page;
(b) a Web browser for requesting the Web page from said Web server, such that when the Web page is received, the embedded object is activated; and
(c) a submission Web server for receiving at least a URL of the Web page upon activation of the embedded object.

14. The system of claim 13, wherein said submission Web server and said Web server are the same server.

15. The system of claim 13, wherein the embedded object comprises an applet.

16. The system of any of claims 13-15, wherein the embedded object comprises a scripting code.

17. The system of claim 13, further comprising:
(e) an autonomous software search program for retrieving said URL from said submission Web server and for providing said URL to said search engine.

18. The system of claim 13, wherein said submission Web server retrieves additional information with said URL, said additional information being provided to said search enginc with said URL.

19. The system of claim 13, wherein the Web page is a dynamic Web page.

20. The system of any of claims 13-19, wherein at least one of said autonomous software search program, said search engine and said submission Web server normalizes the URL for the Web page.

21. The system of claim 20, wherein said normalizing comprises removing at least one redundant parameter from the URL to form a normalized URL.

22. A method for automatically submitting a Web page to a search engine, the Web page featuring an embedded object, comprising:
requesting the Web page by a Web browser;
upon receipt of the Web page by said Web browser, automatically invoking a request for the embedded object; and
receiving at least the URL of the Web page by said search engine through said request.

23. The method of claim 22, wherein the embedded object invokes said request directly.

24. The method of claim 22, wherein said Web browser transmits said request for the embedded object, said automatically invoking further comprising:
receiving said request by an object server, said request including the URL of the Web page; and
transmitting at least the URL of the Web page by said object server.

25. The method of any of claims 22-24, wherein said receiving further comprises:
normalizing the URL for the Web page for said search engine.

26. The method of claim 25, wherein said normalizing comprises removing at least one redundant parameter from the URL to form a normalized URL.

27. A method for normalizing a URL for a Web page, comprising:
removing at least one redundant parameter from the URL to form a normalized URL.

28. The method of claim 27, wherein all redundant parameters are removed.

29. The method of claim 27 or 28, wherein each redundant parameter is removed by:
removing a parameter from the URL to form a reduced URL;
retrieving a new Web page according to said reduced URL; and
comparing said new Web page and the Web page to determine similarity, such that similarity indicates that said parameter is redundant.

30. The method of claim 29, wherein similarity is determined according to content of said new Web page and the Web page.

31. The method of claim 29 or 30, wherein similarity is determined according to a quantitative comparison, such that if similarity is above a threshold, said parameter is redundant.

32. The method of claim 31, wherein said quantitative comparison is determined by comparing content of said new Web page and the Web page.

33. The method of claim 32, wherein said quantitative comparison is performed by also comparing layout of said new Web page and the Web page.

34. The method of claim 32, wherein said quantitative comparison is determined by only comparing content of said new Web page and the Web page, and wherein content comprises at least one of text and image.

35. The method of claims 27-34, wherein the removal of parameters and the comparison of the content in order to determine redundancy of parameters is done either automatically or manually.

36. The method of any of claims 27-35, wherein the URL, is normalized before the Web page is provided to a search engine.

37. A method for ranking a Web page, comprising:
defining a time period for dynamically ranking Web pages;
detecting a request for the Web page from a Web browser;
determining a frequency of requests per said defined time period; and
ranking the Web page according to said frequency of requests per said defined time period to determine the popularity of the Web page.

38. The method of claim 37, wherein the Web page contains an embedded object for reporting a request to download the Web page by a Web browser.

39. The method of claim 38, wherein said embedded object causes said Web browser to invoke a request according to the HTTP protocol, said request being detected to report said request to download the Web page.

40. The method of claim 37, wherein said frequency of requests per time period is used to determine a weight for ranking the Web page.

41. The method of claim 40, further comprising:
searching a plurality of Web pages to provide search results; and
ranking said plurality of Web pages in said search results according to said weight.

42. The method of claim 41, wherein said plurality of Web pages is ranked according to said weight as a primary ranking parameter.

43. The method of claim 41, wherein said plurality of Web pages is ranked according to said weight as a secondary ranking parameter.

44. The method of claim 40, wherein said weight is adjusted according to a popularity of at least one other Web page in a Web site containing the Web page.

45. The method of claim 44, wherein said weight is adjusted according to at least one of a number of times the Web page is viewed by unique users and unique IP addresses.

46. The method of any of claims 37-45, further comprising:
determining a billing rate for an advertisement with the Web page according to said ranking.

47. The method of claim 46, wherein said advertisement is for displaying at least one of a link to the Web page and the Web page in a list, wherein said list is generated by a search engine performing a search for Web pages.

48. The method of claim 46 or 47, wherein said billing rate is for click through on said advertisement.

49. A method for automatically submitting an URI of a document to a repository, the document featuring an embedded object, the method comprising:
requesting the document by a user application capable of displaying the document;
receiving the document by said user application;
automatically invoking a request for the embedded object when displaying the document by said user application; and
receiving at least the address of the document by the repository through said request.

50. The method of claim 49, wherein the embedded object invokes said request directly.

51. The method of claim 50, wherein the embedded object communicates the address to the repository directly.

52. The method of claim 49, wherein said user application transmits said request for the embedded object, and wherein said automatically invoking further comprises:
receiving said request by an object server, said request including the address of the document; and
transmitting at least the address of the document by said object server to the repository.

53. The method of any of claims 49-52, wherein the document comprises an e-mail message, and wherein automatically invoking said request includes information about a time that said e-mail message has been opened by user application.
